(19) United States
(12) Patent Application Publication
(10) Pub. No.: US 2013/0091261 A1
(43) Pub. Date: Apr. 11, 2013

(54) Defining And Managing Virtual Networks In Multi-Tenant Virtualized Data Centers

(71) Applicants: Katherine Barabash, Haifa (IL); Rami Cohen, Haifa (IL); Vinit Jain, Austin, TX (US); Renato J. Recio, Austin, TX (US); Benny Rochwerger, Zichron Yaakov (IL)

(72) Inventors: Katherine Barabash, Haifa (IL); Rami Cohen, Haifa (IL); Vinit Jain, Austin, TX (US); Renato J. Recio, Austin, TX (US); Benny Rochwerger, Zichron Yaakov (IL)

(73) Assignee: INTERNATIONAL BUSINESS MACHINES CORPORATION, Armonk, NY (US)

(21) Appl. No.: 13/253,338

(22) Filed: Oct. 5, 2011

(51) Int. Cl. G06F 15/173

(52) U.S. Cl. 709/223

(57) ABSTRACT

An approach is provided in which a computer system selects a virtual domain from multiple virtual domains, which are each overlayed onto a physical network and are independent of physical topology constraints of the physical network. The computer system selects, from the selected virtual domain, a first virtual group that includes one or more first virtual network endpoints. Next, the computer system selects, from the selected virtual domain, a second virtual group that includes one or more second virtual network endpoints. In turn, the computer system creates a logical link policy that includes one or more actions corresponding to sending data between the first virtual group and the second virtual group.

### BACKGROUND

The present disclosure relates to defining and managing virtual domains, virtual groups, and logical link policies in a multi-tenant virtual domain environment that overlays onto a physical network.

Hardware and software vendors offer virtualization platforms that allow a single physical machine to be partitioned into multiple independent virtual machines. These virtualization platforms have become accepted in the industry market on a small business level and on an enterprise level. Virtualization technology continues to develop in several directions in order to meet the demands of modern IT applications, such as in network services for multi-tenant environments.

### BRIEF SUMMARY

According to one embodiment of the present disclosure, an approach is provided in which a computer system selects a virtual domain from multiple virtual domains, which are each overlayed onto a physical network and are independent of physical topology constraints of the physical network. The computer system selects, from the selected virtual domain, a first virtual group that includes one or more first virtual network endpoints. Next, the computer system selects, from the selected virtual domain, a second virtual group that includes one or more second virtual network endpoints. In turn, the computer system creates a logical link policy that includes one or more actions corresponding to sending data between the first virtual group and the second virtual group.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing a virtual “domain” overlayed onto a physical network;

FIG. 2 is a diagram showing multiple virtual domains overlayed onto a physical network;

FIG. 3 is a diagram showing virtual groups that include endpoints residing on different host servers;

FIG. 4 is a diagram showing virtual endpoints within the same virtual group communicating with each other through a logical link policy;

FIG. 5 is a diagram showing an administrator issuing management overlay commands to a distributed policy service to manage a virtual domain assigned to the administrator;

FIG. 6 is a diagram showing an example of management overlay commands;

FIG. 7 is a flowchart showing steps taken in handling a management overlay CREATE request;

FIG. 8 is a diagram showing virtual domain tables that are specific to a particular virtual domain;

FIG. 9A is a diagram showing an example of a policy resolution request;

FIG. 9B is a diagram showing an example of a policy resolution response;

FIG. 10 is a flowchart showing steps taken in resolving a policy request;

FIG. 11 is a block diagram of a data processing system in which the methods described herein can be implemented; and

FIG. 12 provides an extension of the information handling system environment shown in FIG. 11 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The following detailed description will generally follow the summary of the disclosure, as set forth above, further explaining and expanding the definitions of the various aspects and embodiments of the disclosure as necessary.

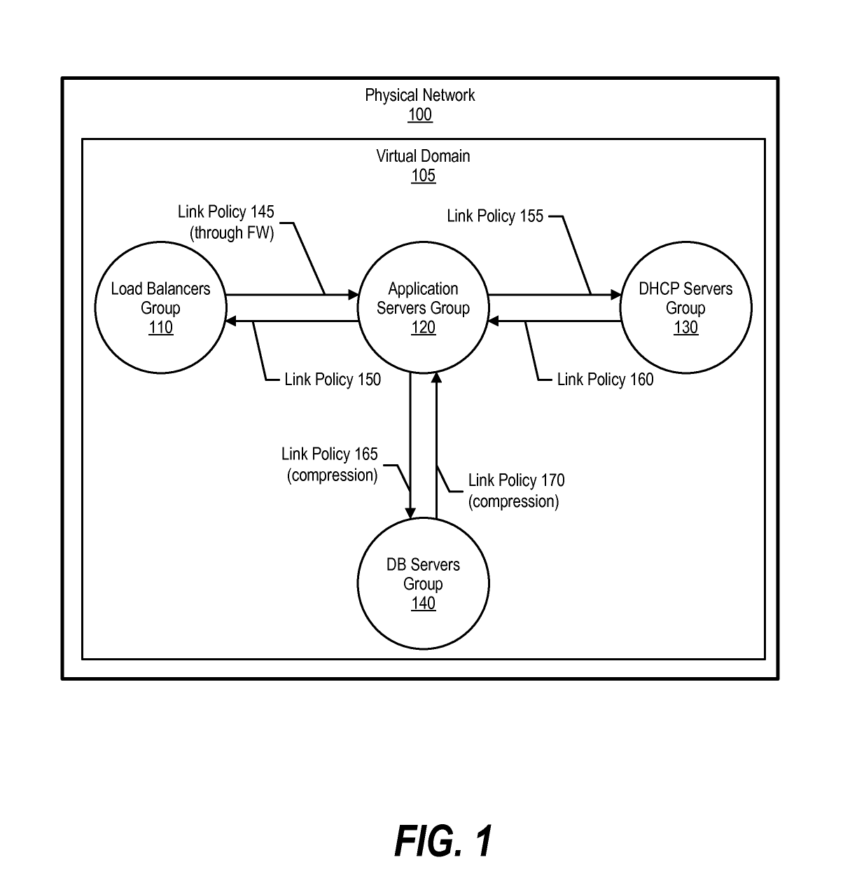

FIG. 1 is a diagram showing a virtual “domain” overlayed onto a physical network. Virtualization is described herein as a service provided to communicating computing nodes, where communication patterns are defined and governed by policies formulated in terms and notions of a virtual nature (as opposed to a network defined in terms of cables, ports and network intermediates). As such, a virtualized system may support a large amount of virtual groups, virtual endpoints, and multiple tenants, all the while achieving independence from a physical infrastructure topology implementation.

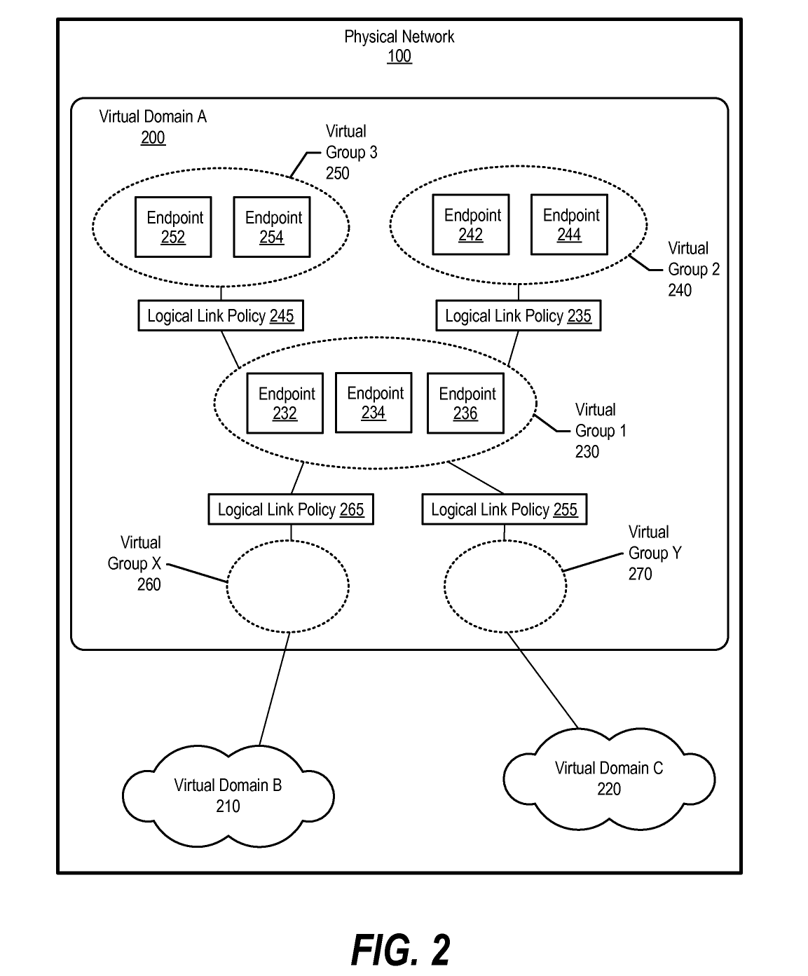

Virtual domain 105 overlays on physical network 100 and includes four defined virtual groups 110-140 with logical link policies 145-170 that “link” the virtual groups together to send and receive data packets. In one embodiment, an administrator may define virtual groups 110-140 and subsequently populate the virtual groups 110-140 with virtual endpoints (e.g., virtual machines). In this embodiment, the amount of virtual endpoints included in a virtual group may dynamically change; while communication rules between the virtual groups for the virtual endpoints are defined by their particular virtual group membership (see FIG. 2 and corresponding text for further details).

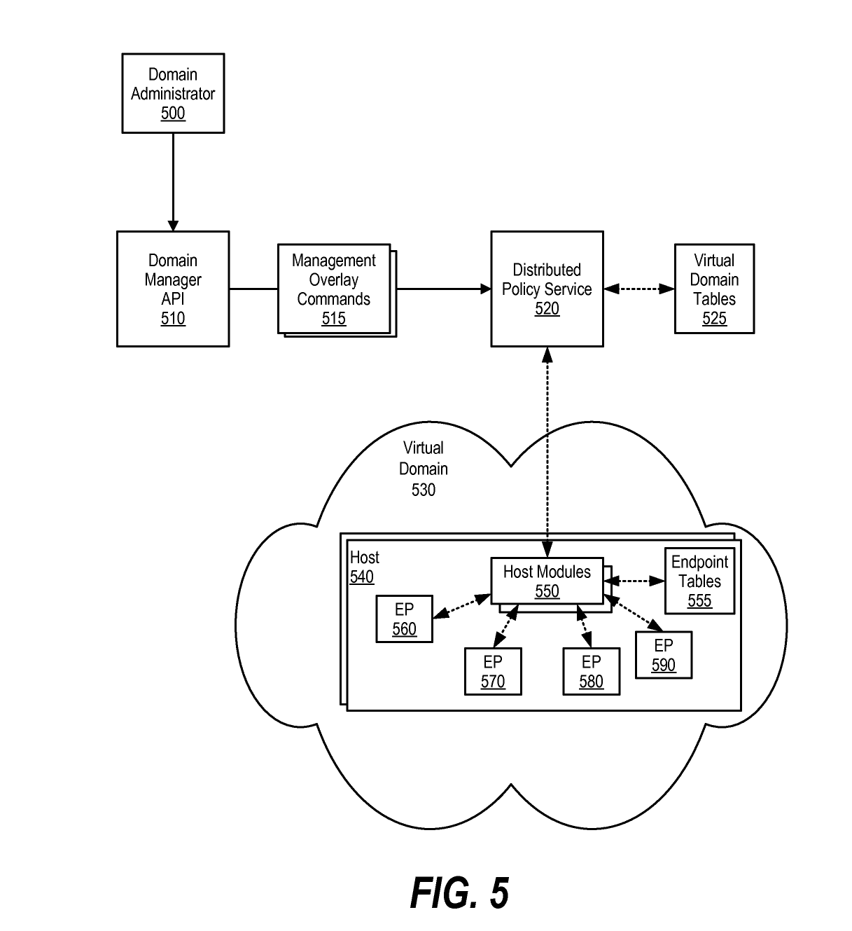

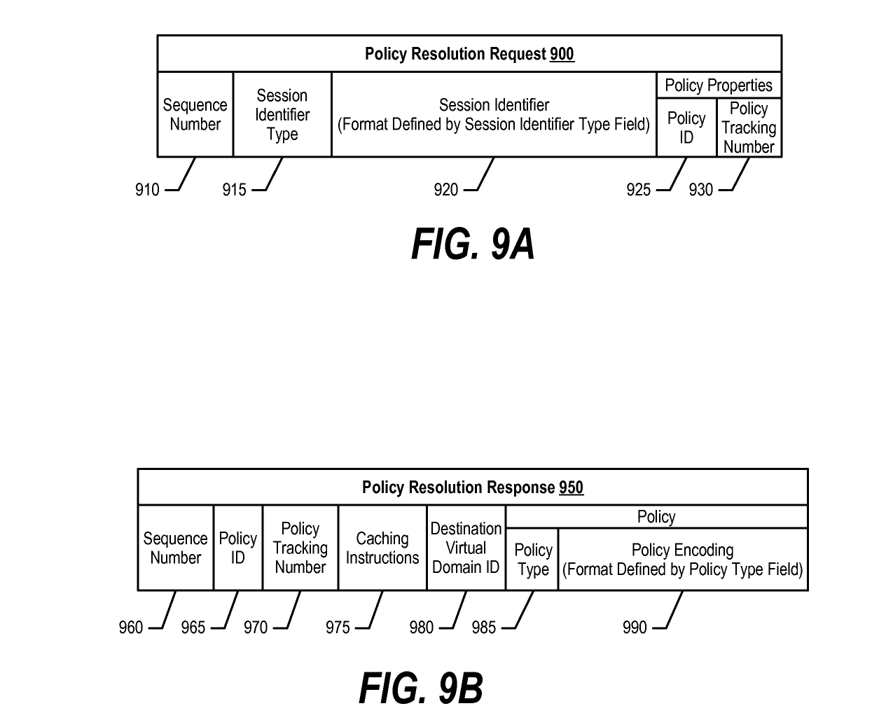

In one embodiment, physical network 100 supports multiple tenants. In this embodiment, virtual domains belonging to different tenants are maintained separately. As such, a tenant administrator for virtual domain 105 is aware of entities within virtual domain 105, but is unaware of physical network 100 or of other tenant's virtual domains. In this embodiment, a distributed policy service maintains logical link policies for each virtual domain overlayed on physical network 100 and actualizes the logical link policies in terms of physical network 100 through physical path translations (see FIGS. 5, 9A-9B and corresponding text for further details).

In one embodiment, a host server includes host modules that communicate with the distributed policy service. In this embodiment, host modules are located on each physical server and physical entry points of physical network 100. Host modules intercept a virtual endpoint's egress and ingress data packets and, if needed, send a request to the distributed policy service to resolve the policies related to the traffic, overlay the traffic (e.g. using tunneling or any other overlay mechanism) according to the acquired policy, and send it onto an underlying physical network. As such, physical network 100 is viewed as a carrier for the overlaid traffic.

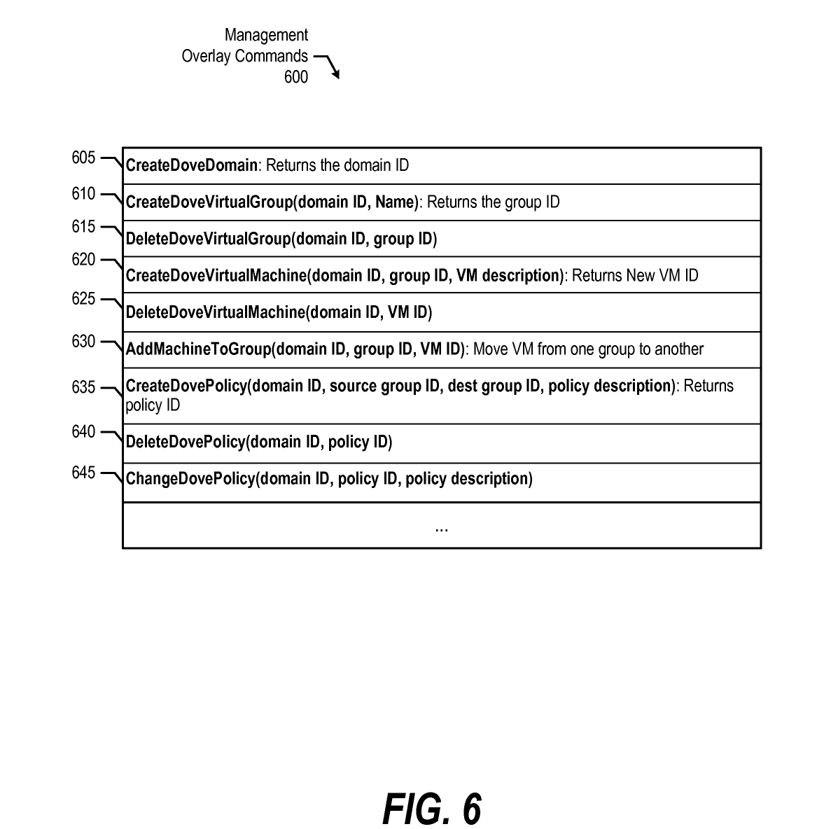

Referring to FIG. 1, an administrator may define, in virtual domain 105, virtual endpoints included in application servers group 120 communicate with virtual endpoints included in load balancers group 110 through link policies 145 and 150. For ingress data traffic, link policy 145 defines that data packets traverse through a mid-point firewall prior to reaching application servers group 120. Application servers group 120 virtual endpoints communicate with virtual endpoints included in DHCP servers group 130 through link policies 155 and 160, which may or may not require mid-point traversals. And, application servers group 120 virtual endpoints communicate with virtual endpoints included in database servers group 140 through link policies 165 and 170, which each require mid-point compression traversals for egress and ingress data traffic. An administrator uses a domain manager API to create and manage logical link policies, virtual groups, and virtual endpoints (see FIGS. 5-6 and corresponding text for further details).

FIG. 2 is a diagram showing multiple virtual domains overlayed onto a physical network. FIG. 2 shows virtual domains 200, 210, and 220 overlayed on physical network 100, each of which may be managed by a different tenant. FIG. 2 also shows an expanded view of virtual domain A 200 and shows its virtual groups, logical link policies, and virtual endpoints. For simplicity purposes, the example in FIG. 2 shows one logical link policy for egress and ingress data traffic between the virtual groups. As discussed herein, a separate logical link policy may be used for egress and ingress data traffic.

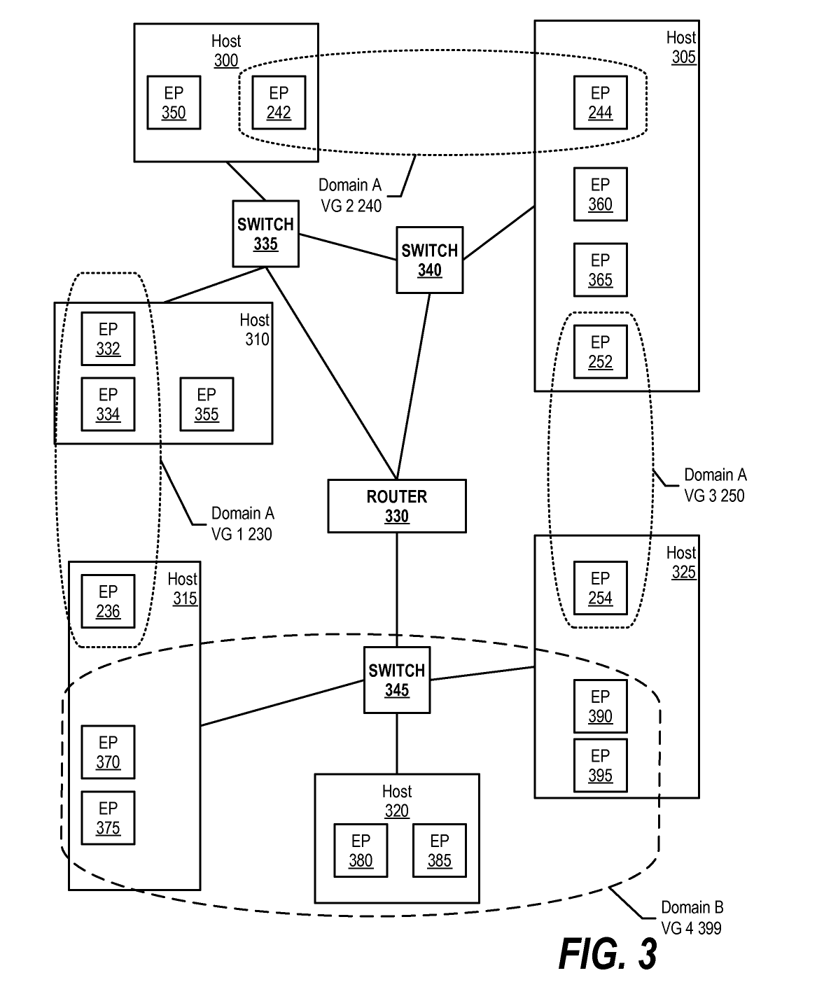

Virtual group 1 230 includes virtual endpoints 232-236. In one embodiment, virtual endpoints 232-236 may reside on a single physical server and share resources. In another embodiment, virtual endpoints may reside on different physical servers that may be physically distant and be defined on different physical subnets (see FIG. 3 and corresponding text for further details). Virtual group 2 240 includes virtual endpoints 242-244. When virtual endpoint 236 sends data to virtual endpoint 242, a host module that hosts virtual endpoint 236 identifies and utilizes logical link policy 235 to send the data to virtual endpoint 242.

Virtual group 3 250 includes virtual endpoints 252 and 254. When virtual endpoint 252 sends data to virtual endpoint 232, a host module that hosts virtual endpoint 252 identifies and utilizes logical link policy 245 to send the data to virtual endpoint 232.

Virtual domain A 200 also includes a mechanism for its virtual endpoints to communicate with endpoints external to itself. Such communication can be of two types: 1) communications initiated by clients in virtual domain A 200 to external servers; and 2) communications initiated by the external clients to servers included in virtual domain A 200. In an embodiment pertaining to the first type of communication, an administrator may define a virtual group (e.g., virtual group X 260 and virtual group Y 270) that includes addresses or domain names of servers that may be contacted from a virtual group included in virtual domain A 200. In this embodiment, link policies (e.g., link policies 255 and 265) are defined to impose constraints on this communication. In an embodiment pertaining to the second type of communication, these types of communications are handled similarly with the exception that a group including external endpoints may not include concrete addresses, but rather address ranges or wildcards that allow internal servers to be contacted from any external client. In both types of communication, an external endpoint may be either an overlay network endpoint belonging to a different domain or endpoint that is not hosted by the overlay network.

The embodiment shown in FIG. 2 allows virtual endpoints in virtual group 1 230 to communicate with external endpoints. In another embodiment, an administrator may create logical link policies to link virtual groups 2 240 and 3 250 to external virtual domains barring any security issues.

FIG. 3 is a diagram showing virtual groups that include endpoints residing on different host servers. FIG. 3 shows a physical network, which includes hosts 300-325, switches 335-345, and router 330. As those skilled in the art can appreciate, a physical network may include more or less component than what is shown in FIG. 3.

Hosts 300-325 execute virtual endpoints (virtual machines), and are grouped according to system administrator preferences. Comparing FIG. 3 with FIG. 2, virtual group 1 230's endpoints 232 and 234 execute on host 310, while endpoint 236 executes on host 315. As can be seen, virtual group 1 230 is independent of physical topology constraints of the physical network, particularly router 330. Host 310 also executes endpoint 355, which may belong to a different domain, a different virtual group, or may be a virtual machine that performs functions such as data compression.

Virtual group 2 240's endpoint 242 executes on host 300, and endpoint 244 executes on host 305. Host 300 also includes endpoint 350. Virtual group 3 250's endpoint 252 executes on host 305, and endpoint 254 executes on host 325. Host 305 also executes endpoints 360 and 365, which may belong to different virtual domains and/or perform particular functions.

Virtual domain B 210, which is a different virtual domain that virtual domain A 200 in which virtual groups 230-250 belong, is also overlayed onto the same physical network. Virtual domain B 210 includes endpoints 370-395, which may or may not belong to the same virtual group within virtual domain B 210. Administrators for virtual domains A and B are able to dynamically manage virtual endpoints assigned to virtual groups using a domain manager API (see FIGS. 5-6 and corresponding text for further details).

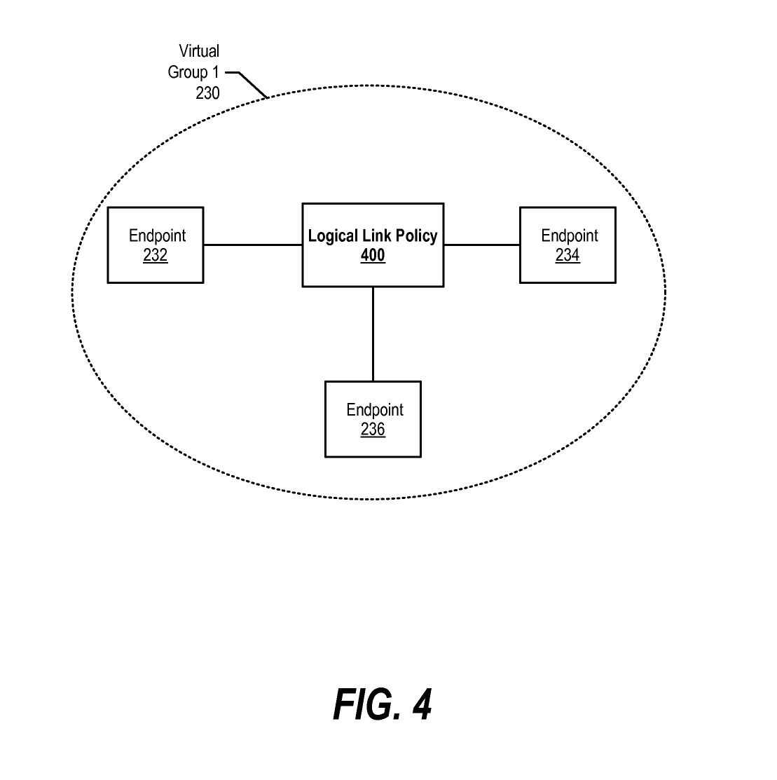

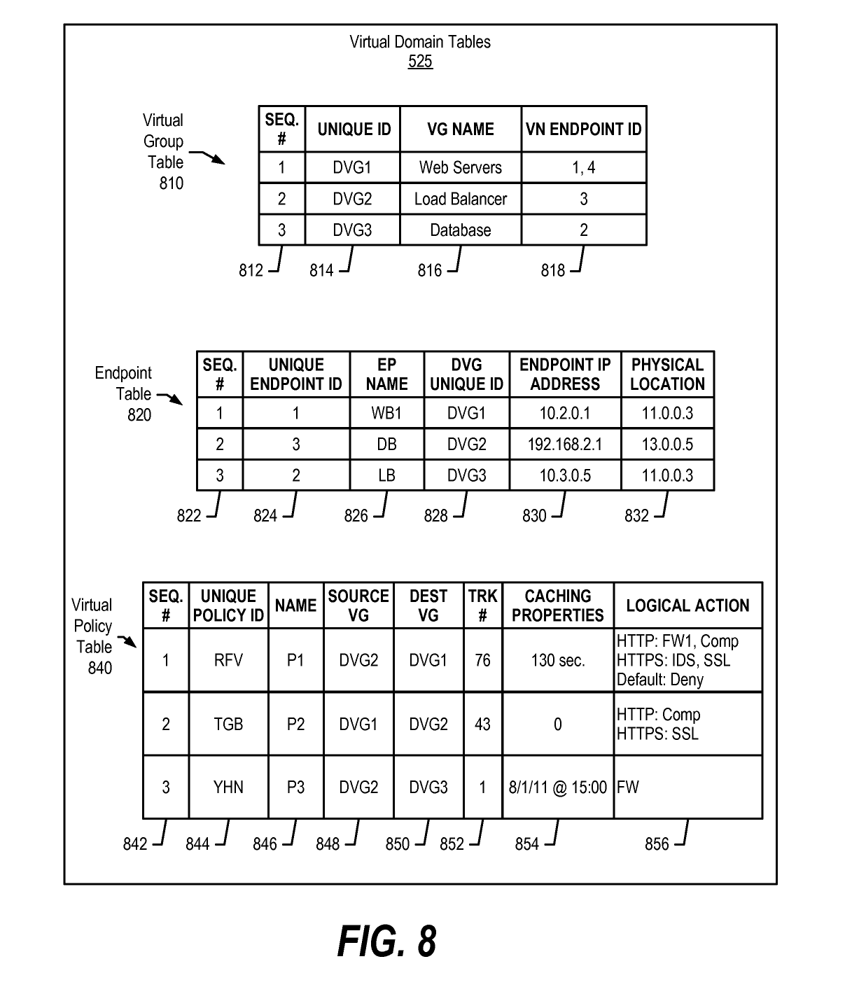

FIG. 4 is a diagram showing virtual endpoints within the same virtual group communicating with each other through a logical link policy. Part of creating a logical link policy is an administrator identifying a source virtual group and a destination virtual group for the logical link policy (see FIG. 8 and corresponding text for further details). Referring to FIG. 1's logical link policy 145, its source virtual group is load balancers group 110 and its destination virtual group is application servers group 120.

An administrator may also create an “internal” logical link policy by defining the source virtual group and the destination virtual group as the same virtual group. FIG. 4 shows logical link policy 400, which has both its source virtual group and its destination virtual group as virtual group 1 230. As such, virtual endpoints 232-236 communicate with each other using logical link policy 400.

FIG. 5 is a diagram showing an administrator issuing management overlay commands to a distributed policy service to manage a virtual domain assigned to the administrator. Distributed policy service 520, while logically a centralized managed entity, is a distributed system that allows for scalability, redundancy and load balancing. Each tenant owns a set of virtual endpoints (e.g., virtual machines) deployed in the system's infrastructure and is given management tools (domain manager API 510) to define communicating subsets of virtual endpoints and policies that govern communications between the virtual endpoints and/or subsets of virtual endpoints (virtual groups). Distributed policy service 525 utilizes virtual domain tables 525 to manage entities within the virtual domain (see FIG. 8 and corresponding text for further details).

Domain administrator 500 uses domain manager API 510 to send management overlay commands 515 to distributed policy service 520. Domain administrator 500 has control over a particular domain, which includes managing virtual groups within the domain and managing virtual endpoints within the virtual groups (see FIG. 6 and corresponding text for further details regarding management overlay command examples).

Domain administrator also uses domain manager API 510 to create and manage logical link policies, which govern communications between virtual endpoints and external network servers, clients, and/or peers. The logical link policies are formulated on a virtual level and govern all the aspects of network communication, such as connectivity, security, QoS, monitoring, etc. Common networking notions of switching and routing are not explicit in policies definitions but are implicitly defined on a higher level by allowing, disallowing, or restricting communications between sets of virtual machines and other network entities.

Distributed policy service 520 receives management overlay commands 515, and informs one or more host modules 550 as to modifications of virtual domain 530. Host modules 550 reside on host 540, and store policy information in local domain tables 555 to support egress and ingress traffic to and from endpoints 560-590. For example, domain administrator 500 may wish to move endpoint 560 to a different virtual group (e.g., VG1 to VG2). In this example, domain administrator 500 uses domain manager API 510 to issue a “AddMachineToGroup” command. In turn, distributed policy service 520 sends instructions to a corresponding host module (host module 550) to store the changes in local endpoint table 555.

FIG. 6 is a diagram showing an example of management overlay commands. Commands 600 includes an example of commands that an administer issues via management API 510 to distributed policy service 520. As will be discussed, an administrator may create virtual groups prior to creating virtual endpoints that are included in the virtual groups.

CREATE commands 605, 610, and 620 get a user specified NAME parameter for an entity (e.g., name of a domain, virtual group, or virtual machine) and return a unique ID generated by the system for the new entity. The system then correlates between the user specified NAME and its unique ID in subsequent interactions. For CreateDoveVirtualGroup command 610, the user specifies the domain ID (returned by the CreateDomain) and the NAME for the new virtual group. The system identifies the domain by the domain ID and creates a new virtual group within the corresponding domain with the user specified virtual group name and system generated virtual group ID.

CreateDoveVirtualMachine command 620 assigns an existing virtual machine (endpoint), which was created when added to the overlay environment, to a domain and virtual group that is specified by the administrator. In another embodiment, a new virtual machine may be instantiated as part of the CreateDoveVirtualMachine command.

DeleteDoveVirtualGroup command 615 deletes a virtual group that corresponds to a domain and virtual group identifier specified by the administrator. DeleteVirtualMachine command 625 deletes a particular virtual machine (endpoint) in a domain specified by the administrator.

AddMachineToGroup command 630 moves an existing virtual machine to a different virtual group. CreateDovePolicy command 635 creates a policy corresponding to a source virtual group and a destination virtual group that resides within a domain, each of which is specified by the administrator. DeleteDovePolicy command 640 deletes a policy corresponding to a policy identifier utilized in a particular domain specified by a domain identifier. ChangeDovePolicy command 645 changes the policy description (e.g., physical path translations) and increments the policy version number of an existing policy that is utilized in a particular domain.

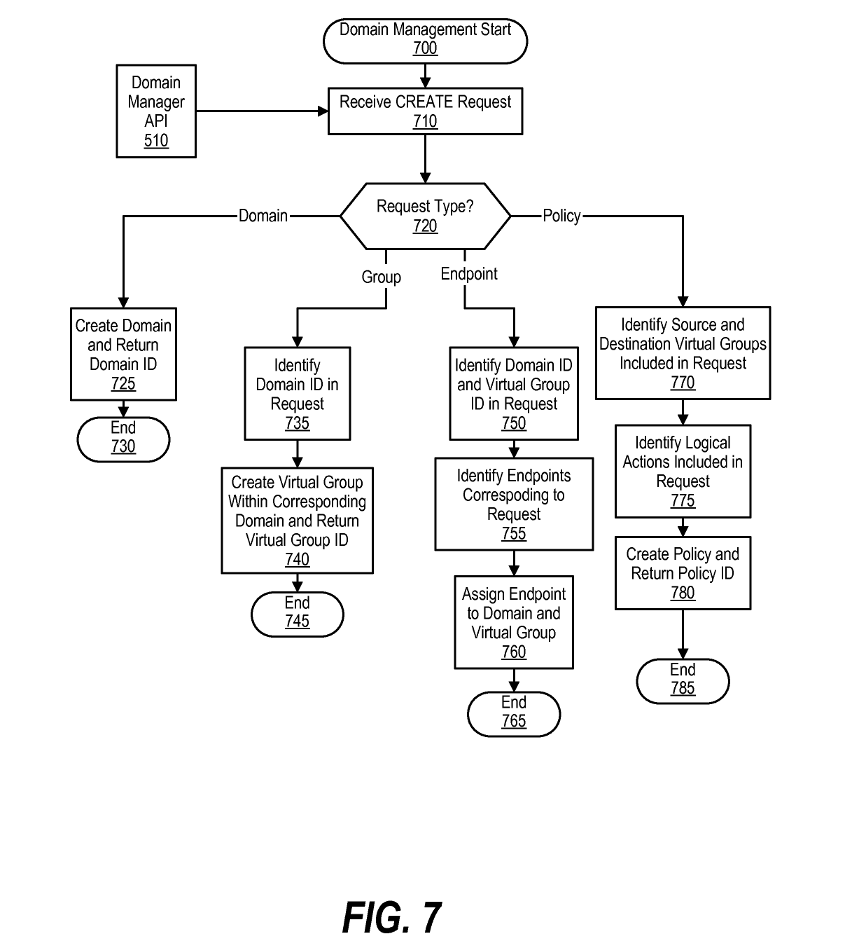

FIG. 7 is a flowchart showing steps taken in handling a management overlay CREATE request. Processing commences at 700, whereupon processing receives a CREATE request from domain manager API 510 at step 710. A determination is made as to whether the request is a domain request, a group request, an endpoint request, or a policy request (decision 720). If the request is a domain creation request, decision 720 branches to the “Domain” branch, whereupon processing creates a domain and returns a unique domain identifier to domain manager API 510 (step 725), which is accessible by administrator 500. Processing ends at 730.

On the other hand, if the request is a group creation request, decision 720 branches to the “Group” branch, whereupon processing identifies a domain identifier specified in the request at step 735, and creates a virtual group within the specified domain at step 740. Processing returns a unique virtual group identifier to domain manager API 510 (step 740), and processing ends at 745.

If the request is an endpoint generation request, decision 720 branches to the “Endpoint” branch, whereupon processing identifies a domain identifier and a virtual group identifier included in the request at step 750. Next, at step 755, processing identifies endpoints (internal and/or external) corresponding to the request. In one embodiment, external endpoints are represented as their globally meaningful IP addresses (or ranges of addresses or wildcards allowing all the addresses) or domain names. External endpoints are assumed to exist somewhere and their existence is not verified. In another embodiment, internal endpoints may either exist before the command or be created by the command. If they exist before the command, their platform-specific identifier is passed as a description. If they are created by the command, a virtual machine specification is passed as a parameter. As one skilled in the art can appreciate, the flowchart may branch into several scenarios depending upon the type of endpoint and whether or not it must be created.

Processing assigns the identified endpoint to the domain and virtual group specified in the request (step 760), and processing ends at 765.

If the request is policy generation request, decision 720 branches to the “Policy” branch, whereupon processing identifies a source virtual group and a destination virtual group included in the request at step 770. Next, at step 775, processing identifies logical actions (policy description) included in the request, such as data should be compressed and/or encrypted. At step 780, processing creates a policy and returns a policy identifier to domain manager API 510 at step 780. Processing ends at 785.

FIG. 8 is a diagram showing virtual domain tables managed by a distributed policy service that are specific to a particular virtual domain. Virtual domain tables 525 include three tables, which are virtual group table 810, endpoint table 820, and virtual policy table 840. Virtual group table 810 includes table entries that identify the virtual groups that belong to the virtual domain. Column 812 includes a sequence number of the virtual group. Column 814 includes a unique virtual group identifier that an administrator uses to define policies and assign virtual endpoints (tables 820 and 840 discussed below). Column 816 includes names that an administrator assigns to a virtual group, and column 818 includes virtual endpoint identifiers that belong to the particular virtual group.

Endpoint table 820 includes columns 822-832. Column 822 includes a sequence number for each virtual endpoint. Column 824 includes a unique endpoint identifier for each virtual endpoint. Column 826 includes a name of the virtual endpoint. Column 828 includes a unique virtual group identifier to which the virtual endpoint belongs. Column 830 includes the IP address of the virtual endpoint, and column 832 includes the IP address of the physical server that hosts the virtual endpoint.

Virtual policy table 840 includes columns 842-856. Column 842 includes a sequence number for each logical link policy. Column 844 includes a unique logical link policy identifier for each logical link policy. Column 846 includes an administrator provided name for the particular logical link policy. Columns 848 and 850 includes a unique source virtual group identifier and a unique destination virtual group identifier to which the policy links, respectively. Column 852 includes a tracking number for each logical link policy, which increments as the policy updates (e.g., a version number). Column 854 includes caching properties for particular logical link policies, which may include an expiration date or an amount of time to include the logical link policy in the cache. And, column 856 includes logical actions for the logical link policies. For example, the first logical link policy (sequence #1) shows that for HTTP traffic, data should traverse through a firewall and compression, and for HTTPS traffic, data should traverse through IDS and SSL. All other types of data traffic are denied. In one embodiment, columns 854-856 may refer to additional tables that the system maintains, such a separate table for caching rules and a separate table for the logical actions.

FIG. 9A is a diagram showing an example of a policy resolution request. A host module sends a policy resolution request to a distributed policy service when the host module needs to handle data sent by its hosted virtual endpoint and the host module is either unable to locate a policy for the data in its local policy table or needs to revalidate its locally stored policy.

Policy resolution request 900 includes fields 910-930. As those skilled in the art can appreciate, a policy resolution request may include more or less fields than what is shown in FIG. 9A. Field 910 includes a request sequence number that the distributed policy service includes in a response to the host module so the host module correlates the response with the corresponding request (see FIG. 9B and corresponding text for further details).

Field 915 includes a session identifier type that identifies the type of session identifier included in field 920, such as a TCP 5 tuples. The session identifier type defines the information that is sent and how it is encoded (includes domain ID). Field 925 includes a policy identifier and field 930 includes a policy tracking number when revalidating an existing policy.

FIG. 9B is a diagram showing an example of a policy resolution response. A distributed policy service sends a policy resolution response to a host module in response to receiving a policy resolution request from the host module.

Policy resolution response 950 includes fields 960-990. As those skilled in the art can appreciate, a policy resolution response may include more or less fields than what is shown in FIG. 9B. Field 960 includes a sequence number that was included in the policy resolution request received at the distributed policy service. This allows the host module to correlate the policy resolution response with its policy resolution request.

Field 965 includes a unique policy identifier that corresponds to the policy included in field 990. This unique policy identifier is stored in the host module's local policy table. Field 970 includes a policy tracking number that identifies a “version” of the policy. In one embodiment, the tracking number is updated each time the policy is updated. Field 975 includes caching instructions for the policy, such as how long a policy should be held in cache or the policy's date of expiration. Field 980 includes a destination domain identifier that corresponds to the destination endpoint. The destination domain may or may not be the same as the source domain of the source endpoint.

Field 985 includes the type of policy included in field 990, such as GRE, IPIP, DEP, MPLS, etc. Field 990 includes the policy (physical path translations) whose format is defined by the policy type included in field 985 (e.g., list of IP addresses, MPLS labels, IP & port remappings, etc.)

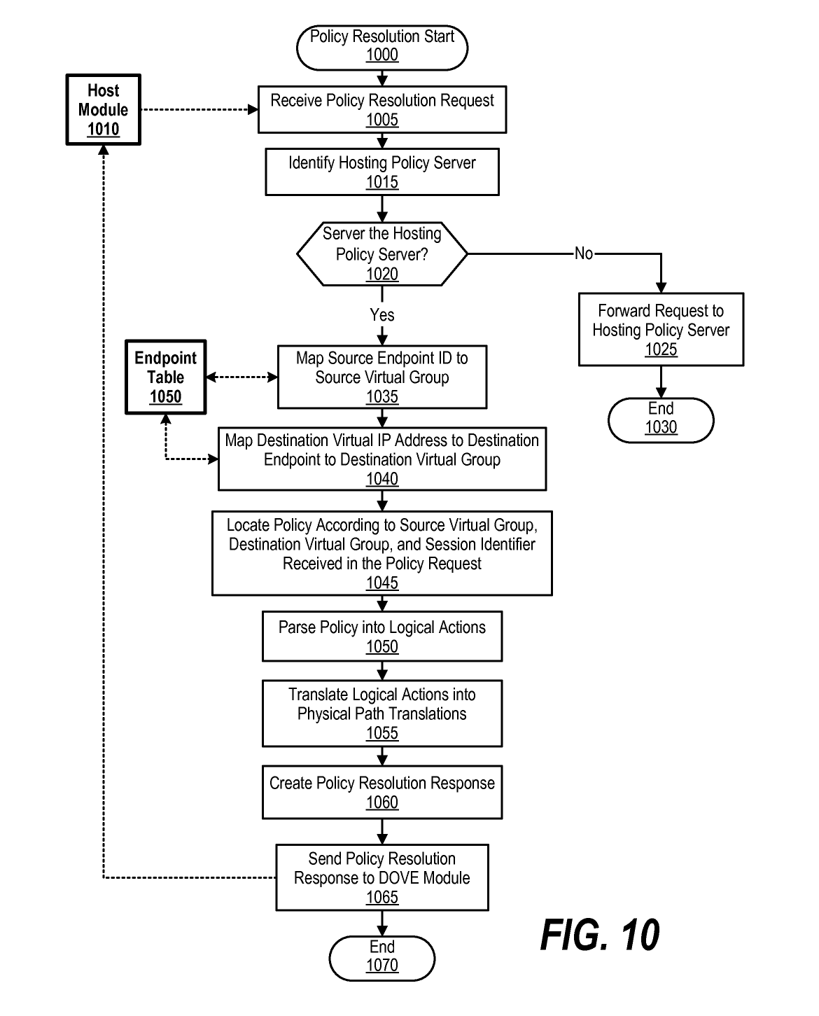

FIG. 10 is a flowchart showing steps taken in resolving a policy request. Processing commences at 1000, whereupon processing receives a policy resolution request from host module 1010 at step 1005. As discussed herein, host modules are a basis for the overlay network and are located on each physical server and physical entry points of the system. Host modules intercept the hosted VMs' egress and ingress data packets and, if needed, send a request to the distributed policy service to resolve the policies related to the traffic, overlay the traffic (e.g. using tunneling or any other overlay mechanism) according to the acquired policy, and send it onto an underlying physical network.

At step 1015, processing identifies the hosting policy server that supports the host corresponding to host module 1010, such as by accessing a lookup table that maps hosts to policy servers. A determination is made as to whether the receiving policy server supports the host corresponding to host module 1010 (decision 1020). If the receiving policy server is not the supporting policy server, decision 1020 branches to the “No” branch whereupon processing forwards the request to the identified policy server that supports the corresponding host system (step 1025), and processing ends at 1030.

On the other hand, if the receiving policy server is the supporting policy server, decision 1020 branches to “Yes” branch 1035, whereupon processing maps a source endpoint identifier (included in the request) to a source virtual group using endpoint table 820 (see FIG. 8 and corresponding text for further details). Next processing maps a destination virtual IP address (included in the request) to a destination endpoint, and then to a destination virtual group using endpoint tale 820 at step 1040.

Now that processing has a source virtual group identifier and a destination virtual group identifier, processing locates a logical link policy using the source virtual group identifier and a destination virtual group identifier at step 1045. At step 1050, processing parses the policy into logical actions (e.g., go through SSL, go through compression, etc.) and translates the logical actions into physical path translations at step 1055. For example, when the destination endpoint is determined, a physical IP address of its hosting local module is determined from endpoint table 1050. This physical address is the simplest resolved policy. In this example, if the policy specifies that traffic must go through a firewall before reaching the destination, the system resolves the firewall physical IP address in addition to the physical IP address of the local module hosting the destination. In turn, the resolved path is “physical firewall IP address, physical destination IP address” and the local module enforces this path onto each data packet that belongs to the data session at hand.

Processing creates a policy resolution response at step 1060, such as that shown in FIG. 9B, and sends the policy resolution response to host module 1010 at step 1065. Processing ends at 1065.

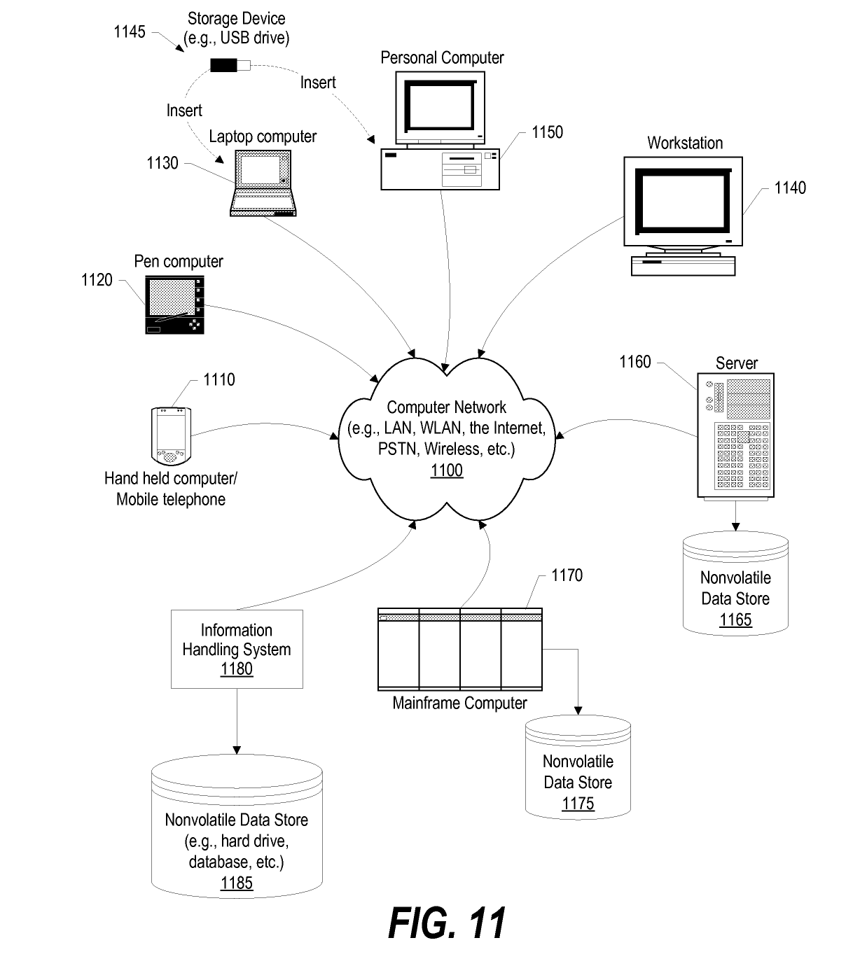

FIG. 11 illustrates information handling system 1100, which is a simplified example of a computer system capable of performing the computing operations described herein. Information handling system 1100 includes one or more processors 1110 coupled to processor interface bus 1112. Processor interface bus 1112 connects processors 1110 to Northbridge 1115, which is also known as the Memory Controller Hub (MCH). Northbridge 1115 connects to system memory 1120 and provides a means for processor(s) 1110 to access the system memory. Graphics controller 1125 also connects to Northbridge 1115. In one embodiment, PCI Express bus 1118 connects Northbridge 1115 to graphics controller 1125. Graphics controller 1125 connects to display device 1130, such as a computer monitor.

Northbridge 1115 and Southbridge 1135 connect to each other using bus 1119. In one embodiment, the bus is a Direct Media Interface (DMI) bus that transfers data at high speeds in each direction between Northbridge 1115 and Southbridge 1135. In another embodiment, a Peripheral Component Interconnect (PCI) bus connects the Northbridge and the Southbridge. Southbridge 1135, also known as the I/O Controller Hub (ICH) is a chip that generally implements capabilities that operate at slower speeds than the capabilities provided by the Northbridge. Southbridge 1135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 1196 and “legacy” I/O devices (using a “super I/O” chip). The “legacy” I/O devices (1198) can include, for example, serial and parallel ports, keyboard, mouse, and/or a floppy disk controller. The LPC bus also connects Southbridge 1135 to Trusted Platform Module (TPM) 1195. Other components often included in Southbridge 1135 include a Direct Memory Access (DMA) controller, a Programmable Interrupt Controller (PIC), and a storage device controller, which connects Southbridge 1135 to nonvolatile storage device 1185, such as a hard disk drive, using bus 1184.

ExpressCard 1155 is a slot that connects hot-pluggable devices to the information handling system. ExpressCard 1155 supports both PCI Express and USB connectivity as it connects to Southbridge 1135 using both the Universal Serial Bus (USB) the PCI Express bus. Southbridge 1135 includes USB Controller 1140 that provides USB connectivity to devices that connect to the USB. These devices include webcam (camera) 1150, infrared (IR) receiver 1148, keyboard and trackpad 1144, and Bluetooth device 1146, which provides for wireless personal area networks (PANs). USB Controller 1140 also provides USB connectivity to other miscellaneous USB connected devices 1142, such as a mouse, removable nonvolatile storage device 1145, modems, network cards, ISDN connectors, fax, printers, USB hubs, and many other types of USB connected devices. While removable nonvolatile storage device 1145 is shown as a USB-connected device, removable nonvolatile storage device 1145 could be connected using a different interface, such as a Firewire interface, etcetera.

Wireless Local Area Network (LAN) device 1175 connects to Southbridge 1135 via the PCI or PCI Express bus 1172. LAN device 1175 typically implements one of the IEEE 802.11 standards of over-the-air modulation techniques that all use the same protocol to wireless communicate between information handling system 1100 and another computer system or device. Optical storage device 1190 connects to Southbridge 1135 using Serial ATA (SATA) bus 1188. Serial ATA adapters and devices communicate over a high-speed serial link. The Serial ATA bus also connects Southbridge 1135 to other forms of storage devices, such as hard disk drives. Audio circuitry 1160, such as a sound card, connects to Southbridge 1135 via bus 1158. Audio circuitry 1160 also provides functionality such as audio line-in and optical digital audio in port 1162, optical digital output and headphone jack 1164, internal speakers 1166, and internal microphone 1168. Ethernet controller 1170 connects to Southbridge 1135 using a bus, such as the PCI or PCI Express bus. Ethernet controller 1170 connects information handling system 1100 to a computer network, such as a Local Area Network (LAN), the Internet, and other public and private computer networks.

While FIG. 11 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

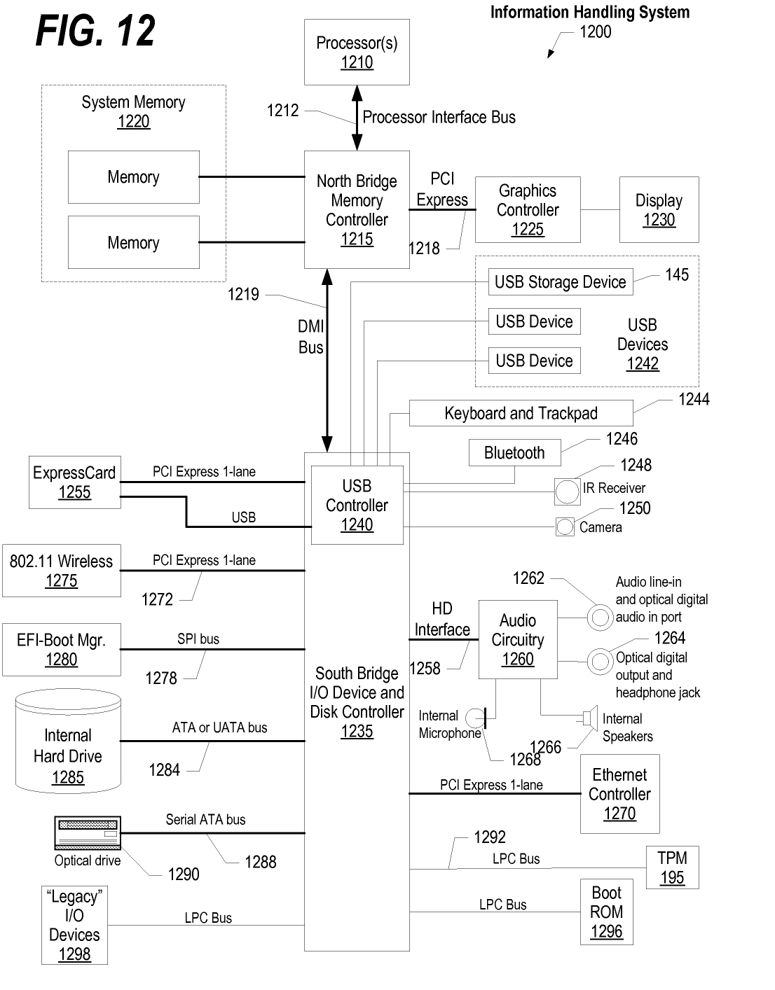

The Trusted Platform Module (TPM 1195) shown in FIG. 11 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 12.

FIG. 12 provides an extension of the information handling system environment shown in FIG. 11 to illustrate that the methods described herein can be performed on a wide variety of information handling systems that operate in a networked environment. Types of information handling systems range from small handheld devices, such as handheld computer/mobile telephone 1210 to large mainframe systems, such as mainframe computer 1270. Examples of handheld computer 1210 include personal digital assistants (PDAs), personal entertainment devices, such as MP3 players, portable televisions, and compact disc players. Other examples of information handling systems include pen, or tablet, computer 1220, laptop, or notebook, computer 1230, workstation 1240, personal computer system 1250, and server 1260. Other types of information handling systems that are not individually shown in FIG. 12 are represented by information handling system 1280. As shown, the various information handling systems can be networked together using computer network 1200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 12 depicts separate nonvolatile data stores (server 1260 utilizes nonvolatile data store 1265, mainframe computer 1270 utilizes nonvolatile data store 1275, and information handling system 1280 utilizes nonvolatile data store 1285). The nonvolatile data store can be a component that is external to the various information handling systems or can be internal to one of the information handling systems. In addition, removable nonvolatile storage device 1145 can be shared among two or more information handling systems using various techniques, such as connecting the removable nonvolatile storage device 1145 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. An information handling system comprising:
one or more processors;
a memory coupled to at least one of the processors;
a set of computer program instructions stored in the memory and executed by at least one of the processors in order to perform actions of:
selecting one of a plurality of virtual domains, wherein each of the plurality of virtual domains is independent of physical topology constraints of a physical network;
selecting a first virtual group corresponding to the selected virtual domain, the first virtual group including one or more first virtual endpoints;
selecting a second virtual group corresponding to the selected virtual domain, the second virtual group including one or more second virtual endpoints; and
creating a logical link policy that includes one or more actions corresponding to sending data between the first virtual group and the second virtual group.

16. The information handling system of claim 15 wherein the information handling system further performs actions comprising:
receiving a policy resolution request from a virtualized domain module, the policy resolution request identifying one of the first virtual endpoints and identifying one of the second virtual endpoints;
mapping the identified first virtual endpoint to the first virtual group;
mapping the identified second virtual endpoint to the second virtual group;
locating the logical link policy in response to the mapping to the first virtual group and the second virtual group;
translating the one or more actions into one or more physical path translations;
creating a policy resolution response that includes the one or more physical path translations; and
sending the policy resolution response to the virtualized domain module.

17. The information handling system of claim 15 wherein the information handling system further performs actions comprising:
prior to selecting one of the plurality of virtual domains:
creating the selected virtual domain;
assigning the selected virtual domain to a system administrator; and
receiving one or more management overlay commands originating from the assigned system administrator, the one or more management overlay commands corresponding to an entity that is selected from the group consisting of the virtual domain, the first virtual group, one of the first virtual endpoints, and the logical link policy.

18. The information handling system of claim 17 wherein the information handling system further performs actions comprising:
creating the first virtual group;
assigning the first virtual group to the system administrator; and
receiving one or more management overlay commands originating from the assigned system administrator, the one or more management overlay commands corresponding to the first virtual group.

19. The information handling system of claim 15 wherein the information handling system further performs actions comprising:
including a policy tracking number in the logical link policy during the creation of the logical link policy;
updating the logical link policy; and
incrementing the policy tracking number in response to updating the logical link policy.

20. The information handling system of claim 15 wherein each of the plurality of virtual domains is independently managed by one of a plurality of heterogeneous tenants, and wherein each of the plurality of virtual domains corresponds to an independent address space and one or more independent security rules.

21. A computer program product stored in a computer readable storage medium, comprising computer program code that, when executed by an information handling system, causes the information handling system to perform actions comprising:
selecting one of a plurality of virtual domains, wherein each of the plurality of virtual domains is independent of physical topology constraints of a physical network;
selecting a first virtual group corresponding to the selected virtual domain, the first virtual group including one or more first virtual endpoints;
selecting a second virtual group corresponding to the selected virtual domain, the second virtual group including one or more second virtual endpoints; and
creating a logical link policy that includes one or more actions corresponding to sending data between the first virtual group and the second virtual group.

22. The computer program product of claim 21 wherein the information handling system further performs actions comprising:
receiving a policy resolution request from a virtualized domain module, the policy resolution request identifying one of the first virtual endpoints and identifying one of the second virtual endpoints;
mapping the identified first virtual endpoint to the first virtual group;
mapping the identified second virtual endpoint to the second virtual group;
locating the logical link policy in response to the mapping to the first virtual group and the second virtual group;
translating the one or more actions into one or more physical path translations;
creating a policy resolution response that includes the one or more physical path translations; and
sending the policy resolution response to the virtualized domain module.

23. The computer program product of claim 21 wherein, prior to selecting one of the plurality of virtual domains, the information handling system further performs actions comprising:
creating the selected virtual domain;
assigning the selected virtual domain to a system administrator;
creating the first virtual group;
assigning the first virtual group to the system administrator; and
receiving one or more management overlay commands originating from the assigned system administrator, the one or more management overlay commands corresponding to an entity that is selected from the group consisting of the virtual domain, the first virtual group, one of the first virtual endpoints, and the logical link policy.

24. The computer program product of claim 21 wherein the information handling system further performs actions comprising:
including a policy tracking number in the logical link policy during the creation of the logical link policy;
updating the logical link policy; and
incrementing the policy tracking number in response to updating the logical link policy.

25. The computer program product of claim 21 wherein each of the plurality of virtual domains is independently managed by one of a plurality of heterogeneous tenants, and wherein each of the plurality of virtual domains corresponds to an independent address space and independent security rules.
